(19) United States
(12) Patent Application Publication
(10) Pub. No.: US 2006/0135098 A1
(43) Pub. Date: Jun. 22, 2006

(54) Method and apparatus for processing digital broadcast audio in the AM/FM bands

(76) Inventors: Matthew J. Yarosz, Kokomo, IN (US); Daniel T. Altizer, Carmel, IN (US)

Correspondence Address: DELPHI TECHNOLOGIES, INC., M/C 480-410-202, PO BOX 5052, TROY, MI, 48007, US

(21) Appl. No.: 11/016,229

(22) Filed: Dec. 17, 2004

(51) Int. Cl. H04B 1/18

(52) U.S. Cl. 455/161.2

(57) ABSTRACT

A receiver includes a processor that processes AM/FM signals and signals from digital broadcasts in the AM/FM bands. The processor includes a digital broadcast audio processing controller and a digital broadcast audio processor. Upon determining an increased probability of an imminent digital broadcast audio dropout, the digital broadcast audio processing controller gradually increases the processing applied to digital broadcast audio by the digital broadcast audio processor. A method for providing a transition between AM/FM audio and audio from digital broadcasts in the AM/FM bands is also disclosed.

### TECHNICAL FIELD

The present invention generally relates to vehicular audio systems. In particular, the present invention relates to vehicular audio systems equipped to receive both AM/FM audio and audio from a digital broadcast in the AM/FM bands.

### BACKGROUND OF THE INVENTION

It is known in the art that AM and FM radio stations are allowed to simulcast their AM/FM audio content using an accompanying digital broadcast. One form of digital broadcast in the AM/FM bands is commercially available under the tradename HD RADIO® from iBiquity Digital Corporation of Columbia, Md. Unlike the gradual changes in reception quality common with AM/FM audio, reception quality of digital broadcast audio is nearly perfect until the signal quality falls below a certain threshold, and then audio is lost entirely. FIG. 1 shows how a conventional receiver 100 for receiving both digital and AM/FM broadcasts handles the loss of digital broadcast audio. The conventional receiver 100 switches to AM/FM audio 120 when digital broadcast audio 122 is lost to prevent mutes in the audio output that would otherwise occur. When the digital broadcast audio 122 is reacquired, the receiver 100 switches back to the digital broadcast audio 122.

At the receiver 100, an AM/FM signal 110 and a digital broadcast signal 108 share the same antenna 102, RF front end tuner 104, and A/D converter 106 before the digital broadcast signal 108 splits from the AM/FM signal 110. At this stage, the AM/FM signal 110 enters an AM/FM detector and decoder 112 as the digital broadcast signal 108 enters a digital broadcast decoder 114. After exiting the AM/FM detector and decoder 112, AM/FM audio 116 undergoes processing at block 118 to reduce noise under impaired signal conditions. Then, processed AM/FM audio 120 exits the processing block 118 to a blend function 125 that implements gradual transitions between digital broadcast audio 122 and the processed AM/FM audio 120.

The digital broadcast audio 122, on the other hand, travels from the digital broadcast decoder 114 directly to the blend function 125. If the digital broadcast decoder 114 detects an imminent reception loss, the digital broadcast decoder 114 provides a digital broadcast audio dropout indicator 124 to the blend function 125. The blend function 125 then responds by initiating a gradual transition from the digital broadcast audio 122 to the processed AM/FM audio 120. When digital broadcast audio 122 is reacquired, the blend function 125 initiates a gradual transition to return to the digital broadcast audio 122 from the processed AM/FM audio 120.

The conventional receiver 100 attempts to disguise the transitions between AM/FM audio 120 and digital broadcast audio 122 through static time alignment and volume equalisation of the two audio sources. When the transition occurs, the receiver 100 linearly fades from one audio source to the other audio source in the blend function 125. Despite these attempts to disguise the transition between the AM/FM and digital broadcast audio, the transitions are still rather noticeable, largely due to differences between the two audio sources in the areas of frequency content, stereo separation, and volume.

### BRIEF DESCRIPTION OF THE DRAWINGS

The present invention will now be described, by way of example, with reference to the accompanying drawings, in which:

FIG. 1 is a block diagram of a conventional receiver that processes digital broadcast audio and AM/FM audio;

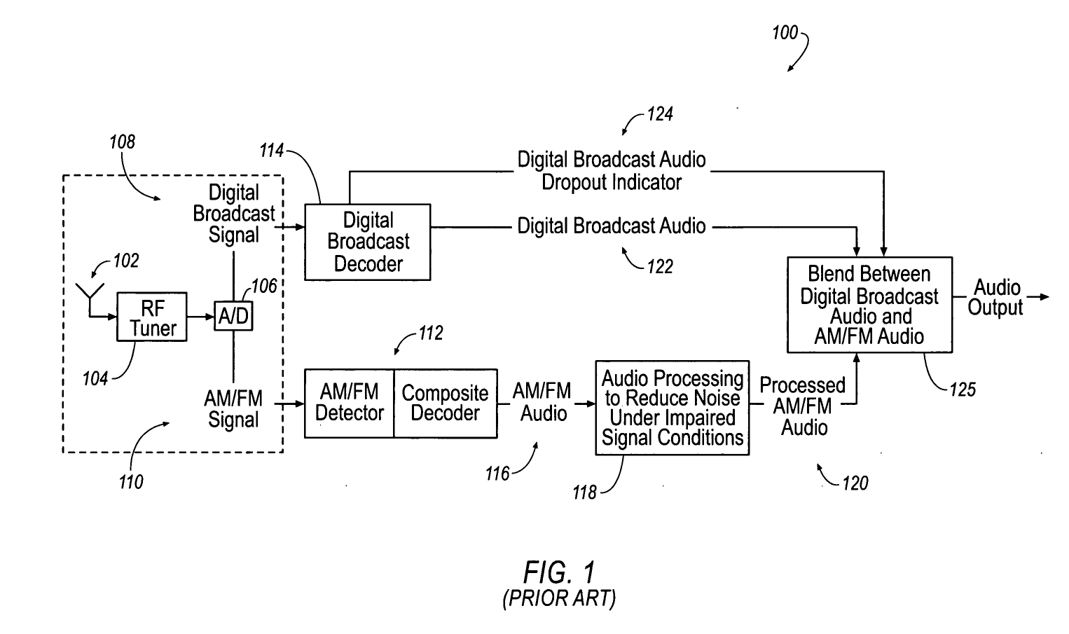

FIG. 2 is a block diagram of a receiver that processes digital broadcast audio and AM/FM audio according to an embodiment;

FIG. 3 is a block diagram illustrating a portion of the receiver according to FIG. 2;

FIG. 4 is a block diagram of FM mode processing according to an embodiment of the receiver illustrated in FIG. 2; and

FIG. 5 is a block diagram of AM mode processing according to an embodiment of the receiver illustrated in FIG. 2.

### DESCRIPTION OF THE PREFERRED EMBODIMENT

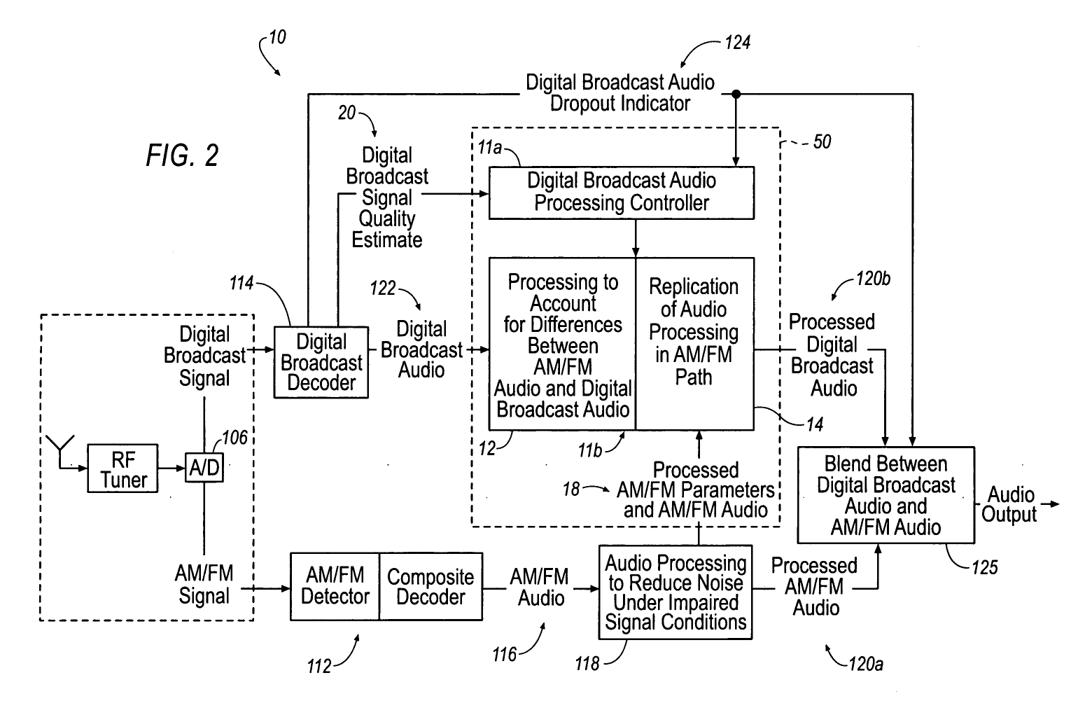

Referring to FIG. 2, a receiver 10 has been realized that processes both digital broadcast audio in the AM/FM bands and AM/FM audio to more effectively disguise the switching between AM/FM audio and digital broadcast audio in the AM/FM bands. In the following description and related drawings, the terminology relating to ‘digital broadcast audio in the AM/FM bands’ is hereinafter referred to as ‘digital broadcast audio.’

According to one aspect of the invention, the receiver 10 includes improved digital broadcast audio processing, which is referenced generally at reference numeral 50. The processing 50 includes a controller block 11a and a multi-stage processing block 11b, which includes first and second processing stages 12, 14. According to an embodiment, the processing 50 represents a digital signal processing (DSP) core including software that resides on a baseband processor integrated circuit (IC). As illustrated, the processing 50 outputs processed digital broadcast audio, which is generally referenced at 120b, to the blending blend function 125. The processing 50 is designed such that, at the moment of transition between the digital broadcast audio 120b and AM/FM audio 120a, the processed digital broadcast audio 120b has audio characteristics substantially similar to those of the processed AM/FM audio 120a. Therefore, the audio transitions between the digital broadcast audio 120b and the AM/FM audio 120a are more effectively disguised.

As discussed above, the processing block 11b has two stages. The first stage accounts for inherent differences between AM/FM audio 116 and digital broadcast audio 122 at block 12, which compensates for frequency content and stereo separation differences between the AM/FM audio and digital broadcast audio streams. For example, the digital broadcast audio 122 has slightly more extensive frequency content than FM audio 116 (e.g., FM audio 116 contains no frequencies above 19 kHz and is usually limited to approximately 15 kHz, whereas audio from digital broadcasts 122 in the FM band contains frequencies up to 20 kHz) and significantly more extensive frequency content than AM audio 116 (e.g., AM audio 116 is typically limited to about 8 kHz, whereas audio from digital broadcasts in the AM band contains frequencies up to 15 kHz). Furthermore, digital broadcast audio 122 is typically in full stereo whereas most AM audio is mono and FM audio stereo separation is slightly more limited than that of digital broadcast audio.

The second stage, which is referenced generally at block 14, accounts for the changes made to the AM/FM audio 116 in the AM/FM audio processing block 118. These changes are communicated to the processing block 50 as a number of audio processing parameters 18. These parameters include coefficients for the blend to mono function, the frequency reduction function, and volume attenuation function, which are commonly used in AM/FM audio processing to reduce noise during weak RF signal conditions. Using these parameters, block 14 applies the same levels of blend to mono, frequency reduction, and volume attenuation to the digital broadcast audio 122 when a digital broadcast audio dropout is imminent. It should also be noted that AM/FM audio is conveyed to block 14 for dynamic volume equalization.

The degree of processing in block 50 is controlled by a digital broadcast signal quality estimate 20 and the digital audio dropout indicator 124, both of which originate from the digital broadcast decoder 114. When digital broadcast audio 122 is available and the digital broadcast signal quality estimate 20 corresponds to a low probability of a digital broadcast audio dropout, the controller block 11a disables the processing in blocks 12, 14. Accordingly, when blocks 12, 14 are disabled, the processing block 50 seems transparent to the digital broadcast audio 122, and essentially disappears. However, as the digital broadcast signal quality worsens and the signal quality estimate 20 corresponds to a high probability of a digital broadcast audio dropout, the controller block 11 a permits a gradual increase in the amount of processing at processing blocks 12, 14 in an attempt to match the processed digital broadcast audio 120b to the processed AM/FM audio 120a. When the signal quality estimate 20 corresponds to the highest probability of a digital broadcast audio dropout, processing blocks 12, 14 cause the processed digital broadcast audio 120b to sound nearly identical to the processed AM/FM audio 120a in anticipation of the impending blend from processed digital broadcast audio 120b to processed AM/FM audio 120a at block 125.

According to an embodiment, the digital broadcast signal quality estimate 20 may be a carrier to noise ratio (CNR). For example, with regard to a digital broadcast in the FM band, a CNR of fifty-four or lower would correspond to the highest probability of a digital broadcast audio dropout over an ensuing brief time period, such as, for example, approximately ten seconds. A CNR of fifty-nine or higher would correspond to a very low probability of a digital broadcast audio dropout over the ten-second period. For CNRs of fifty-five, fifty-six, fifty-seven, and fifty-eight, the probability of a digital broadcast audio dropout over a ten-second period may be approximately 70%, 50%, 30%, and 10%, respectively, over the ten-second time period. Thus, there is a low probability of a digital broadcast audio dropout when the CNR falls within an approximate range of fifty-seven to fifty-nine, and there is a high probability of a digital broadcast audio dropout when the CNR falls within an approximate range of fifty-four to fifty-six. It will be appreciated that time periods other than the ten second time period discussed above may be applied when approximating the dropout probability; however, relatively short time periods, such as one ms, may consistently return a low dropout probability, whereas relatively long time periods, such as one hour, may consistently return a high dropout probability. It will also be appreciated that the CNR values listed above have meaning for one particular embodiment and are provided for explanatory purposes only.

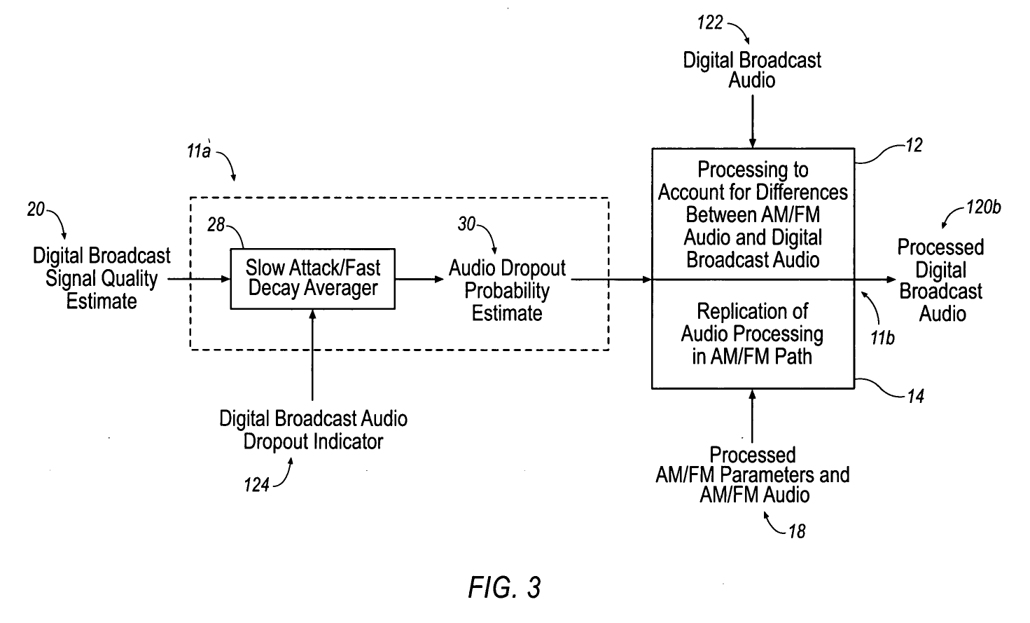

Referring to FIG. 3, the controller block 11a is shown to include a slow attack/fast decay averager 28 that produces an audio dropout probability estimate 30. The slow attack/fast decay behavior of the averager 28 provides a quick response to decreases in signal quality, and conversely, a slow response to increases in signal quality; thus, the averager 28 prevents unnecessarily abrupt changes in the amount of digital broadcast audio processing in blocks 12, 14.

As illustrated, the digital broadcast signal quality estimate 20 and the digital broadcast audio dropout indicator 124 are input to the averager 28. The averager 28 uses the digital broadcast signal quality estimate 20 to calculate the audio dropout probability estimate 30. The audio dropout probability estimate 30, which is a scaled and averaged version of the digital broadcast signal quality estimate 20, controls the degree to which the digital broadcast audio processing is active at processing blocks 12, 14. When the audio dropout probability estimate 30 indicates that the digital broadcast audio 122 is acceptable (i.e., a low dropout probability), no effective processing is applied to the digital broadcast audio 122 at processing block 12. Consequently, the digital broadcast audio 122 is passed unchanged to block 125. However, as signal conditions of the digital broadcast audio 122 worsen (i.e., a high dropout probability), the audio dropout probability estimate 30 gradually and increasingly activates processing of the digital broadcast audio 122 at processing blocks 12, 14 to more closely match the processed digital broadcast audio 120b with the processed AM/FM audio 120a prior to an audio transition at block 125. Accordingly, the slow attack/fast decay averager 28 prevents rapid changes in audio quality, even when repeated digital broadcast audio dropouts occur under what would otherwise appear to be strong signal conditions.

When digital broadcast audio dropouts occur unexpectedly, the digital broadcast audio dropout indicator 124 acts as an override function so as to quickly set the output of the averager 28 to its minimum value, thereby fully engaging the controller block 11a. Accordingly, the digital broadcast audio dropout indicator 124 acts as a safety indicator when the digital broadcast signal quality estimate 20 fails to accurately predict digital broadcast audio dropouts (e.g., when a vehicle travels under an overpass and the signal quality changes rather abruptly). As such, when the digital broadcast audio dropout indicator 124 activates, the controller block 11a fully engages and remains fully engaged until digital broadcast audio 122 is reacquired. After reacquisition, the controller block 11a slowly disengages, even if signal conditions rapidly improve, to prevent a noticeable and abrupt transition from the AM/FM audio 116 to the digital broadcast audio 122.

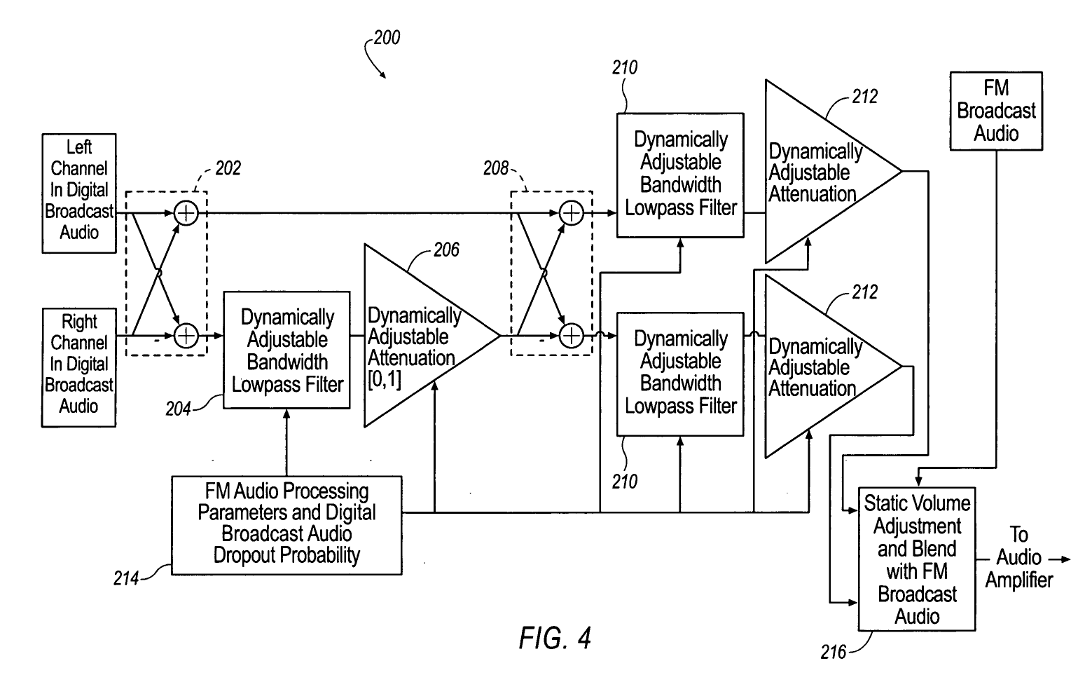

FM receivers employ techniques to reduce noise during weak RF signal conditions. One such technique commonly used in automotive FM receivers is audio processing called “weak-signal handling” that gradually reduces stereo separation, frequency content, and volume as RF signal conditions worsen. Shown generally at 200 in FIG. 4 is a duplication of this FM audio processing in the receiver's digital broadcast audio path. Block 214 represents a combination of the digital FM audio dropout probability estimate 30, the audio processing parameters from the AM/FM audio path, and AM/FM audio 18, as illustrated in FIGS. 2 and 3. First, the digital broadcast audio is matrixed into the L+R mono content and L−R stereo content at block 202 to emulate the L+R and L−R processing that occurs in the FM broadcast audio path. The digital broadcast L−R stereo audio enters a dynamically adjustable lowpass filter 204 and then is subjected to an adjustable attenuation 206. Next, a de-matrixing function 208 is performed to again separate the left and right hand digital broadcast audio channels before entering the high frequency roll-off blocks 210. Finally, adjustable attenuation 212 may be applied to match the attenuation applied by the soft mute function in the FM audio path. By applying from block 214 a combination of the information about the digital broadcast audio dropout probability and information about the current state of the FM path audio processing, each digital broadcast audio processing block 204, 206, 210, 212 is adjusted appropriately. It will be appreciated that the structure illustrated in FIG. 4 may also be used in the case of an AM stereo capable receiver.

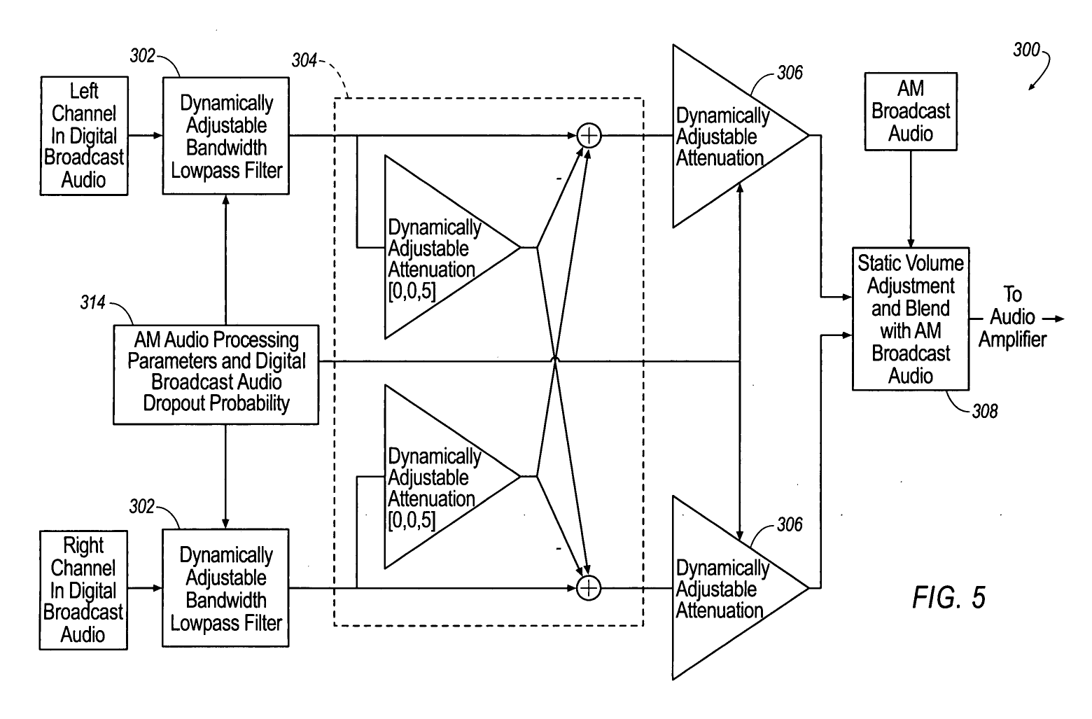

Shown generally at 300 in FIG. 5 is the processing on the audio from the digital broadcast in the AM band. This processing resides within the receiver 10, and it accounts both for the processing that occurs in the AM audio path, and to a greater extent, for the audio quality differences that exist between digital broadcast audio and AM audio. First, parameters from AM weak signal handling algorithms at block 314, which are similar to the above-described block 214 in FIG. 4, are input to adjustable lowpass filters 302. The adjustable lowpass filters 302 are applied to reduce, when necessary, the 15 kHz bandwidth of the digital broadcast audio to the low audio bandwidths that are typically passed for AM audio. Then, a subsequent blend-to-mono matrix 304 allows for full stereo separation, but may be adjusted down to the complete mono of typical AM broadcasts when dropouts are imminent. Then, a variable attenuation 306 can be applied according to the parameters from block 314 to match the attenuation applied by the soft mute function in the AM audio path.

Having been appropriately processed as described in FIGS. 4 and 5, the digital broadcast audio may enter the respective blocks 216, 308 in the receiver 10 for applying static volume adjustments and for making the transition from the processed digital broadcast audio 120b to the processed AM/FM audio 120a upon encountering digital broadcast audio dropouts. Accordingly, the processing 50 is designed to allow the processed digital broadcast audio 120b to sound as much as possible like the processed AM/FM audio 120a when a transition from digital broadcast audio 122 to AM/FM audio 116 is imminent as a result of encountering weak signal conditions a digital broadcast audio dropout.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A receiver, comprising:
a processor that processes AM/FM signals and signals from digital broadcasts in the AM/FM bands, wherein the processor includes a digital broadcast audio processing controller and a digital broadcast audio processor, wherein, upon determining an increased probability of an imminent digital broadcast audio dropout, the digital broadcast audio processing controller gradually increases the processing applied to digital broadcast audio by the digital broadcast audio processor to cause the digital broadcast audio to include substantially similar audio characteristics of processed AM/FM audio.

2. The receiver according to claim 1, wherein the digital broadcast audio processor includes a first processing stage and a second processing stage,
wherein the first processing stage compensates for frequency content differences and stereo separation differences between the AM/FM audio and the digital broadcast audio, and
wherein the second processing stage accounts for the changes made to the AM/FM audio in an AM/FM audio processor.

3. The receiver according to claim 1, wherein the processing applied to the digital broadcast audio is regulated by a digital broadcast signal quality estimate sent from a digital broadcast decoder to the digital broadcast audio processing controller, wherein the digital broadcast signal quality estimate provides an indication to the digital broadcast audio processing controller of the probability of an imminent digital broadcast audio dropout.

4. The receiver according to claim 3, wherein the digital broadcast signal quality estimate is a carrier-to-noise ratio.

5. The receiver according to claim 3, wherein the digital broadcast audio processing controller includes a slow attack/fast decay averager that provides a digital broadcast audio dropout probability estimate to the digital broadcast audio processor.

6. The receiver according to claim 5, wherein the slow attack/fast decay averager is adapted to receive a digital broadcast audio dropout indicator that acts as an override function when the digital broadcast signal quality estimate does not quickly respond to the digital broadcast audio dropout.

7. A method for providing a transition between AM/FM audio and audio from digital broadcasts in the AM/FM bands, comprising the steps of:
processing audio from digital broadcasts in the AM/FM bands in a digital broadcast audio processor; and
upon determining an increased probability of an imminent digital broadcast audio dropout, regulating processing applied to the audio from digital broadcasts in the AM/FM bands.

8. The method according to claim 7, wherein the processing applied to the digital broadcast audio in the AM/FM bands includes compensating for frequency content and stereo separation differences between AM/FM audio and digital broadcast audio in the AM/FM bands, and accounting for the changes made to the AM/FM audio in an AM/FM audio processor.

9. The method according to claim 7 further comprising the step of determining a degree of processing applied to the digital broadcast audio in the AM/FM bands by the digital broadcast audio processor by providing a digital broadcast signal quality estimate from a digital broadcast decoder to a digital broadcast audio processing controller.

10. The method according to claim 9 further comprising the step of increasing or decreasing the degree of processing applied to the digital broadcast audio in the AM/FM bands when the digital broadcast signal quality estimate indicates a high or low digital broadcast audio dropout probability, respectively.

11. The method according to claim 9, further comprising the steps of receiving a digital broadcast audio dropout indicator at the digital broadcast audio processing controller, overriding the digital broadcast signal quality estimate, and maximizing the degree of processing applied to the digital broadcast audio in the AM/FM bands.
